(19) United States
(12) Patent Application Publication
(10) Pub. No.: US 2026/0099108 A1
(43) Pub. Date: Apr. 9, 2026

(54) POSITIVELY CHARGEABLE MAGNETIC ONE-COMPONENT TONER

(71) Applicant: KYOCERA Document Solutions Inc., Osaka (JP)

(72) Inventor: Seiji KIKUSHIMA, Osaka (JP)

(73) Assignee: KYOCERA Document Solutions Inc., Osaka (JP)

(21) Appl. No.: 19/346,747

(22) Filed: Oct. 1, 2025

(30) Foreign Application Priority Data
Oct. 7, 2024 (JP) 2024-176025

(51) Int. Cl. G03G 9/093; G03G 9/083; G03G 9/087

(52) U.S. Cl. CPC G03G 9/09342; G03G 9/083; G03G 9/08755

(57) ABSTRACT

Positively chargeable magnetic one-component toner includes a toner particle having: a toner base particle containing at least a binder resin and a magnetic powder; and an external additive attached to the surface of the toner base particle. When the toner is mixed with standard carrier P-01 for 10 minutes such that the mass mixture ratio of the toner to the carrier is x (x=0.2, 0.4, 0.6, 0.8, or 1.0) and that the charge amount of the carrier is y, the approximation expression y=b*x^{a} of the charge amount of the carrier fulfills 0.3≤a≤1 and −7≤b≤−3.

### INCORPORATION BY REFERENCE

This application is based on and claims the benefit of priority from Japanese Patent Application No. 2024-176025 filed on Oct. 7, 2024, the contents of which are hereby incorporated by reference.

### BACKGROUND

The present disclosure relates to positively chargeable magnetic one-component toner.

In general, in electrophotography, the surface of an electrostatic latent image carrying member is electrostatically charged by corona discharge or the like and is then exposed to laser light or the like to form an electrostatic latent image. The formed electrostatic latent image is developed with toner to form a toner image. The formed toner image is then transferred to a recording medium to obtain a high-quality image. Typically, as toner for use in such electrophotography, a binder resin such as a thermoplastic resin is blended with a colorant, a charge control agent, a release agent, a magnetic material, and the like and the mixture is then subjected to kneading, pulverization, and classification to obtain toner particles (toner base particles) with an average particle size of 5 μm or more but 10 μm or less. Then, for the purposes of giving the toner fluidity, giving it satisfactory charging properties, and improving the cleaning properties of the toner against a photosensitive drum, an inorganic fine powder such as silica or titanium oxide is externally added to the toner base particles.

### SUMMARY

According to one aspect of the present disclosure, positively chargeable magnetic one-component toner includes a toner particle having: a toner base particle containing at least a binder resin and a magnetic powder; and an external additive attached to the surface of the toner base particle. When the toner is mixed with standard carrier P-01 for 10 minutes such that the mass mixture ratio of the toner to the carrier is x and that the charge amount of the carrier is y, the approximation expression y=b*x^{a} of the charge amount of the carrier fulfills conditions (1) and (2) below:

$$0.3 \leq a \leq 1 \qquad ( 1 )$$

$$- 7 \leq b \leq - 3 \qquad ( 2 )$$

where x=0.2, 0.4, 0.6, 0.8, or 1.0.

### BRIEF DESCRIPTION OF THE DRAWINGS

FIG. 1 is a graph showing the relationship between carrier charge amount and toner core (T/C).

FIG. 2 is an electron microscope image showing the condition of toner and carrier mixed at a toner concentration of 10%.

FIG. 3 is an electron microscope image showing the condition of toner and carrier mixed at a toner concentration of 20%.

FIG. 4 is an electron microscope image showing the condition of toner and carrier mixed at a toner concentration of 40%.

FIG. 5 is an electron microscope image showing the condition of toner and carrier mixed at a toner concentration of 60%.

### DETAILED DESCRIPTION

An embodiment of the present disclosure will be described in detail below. Unless otherwise defined, a result of evaluation (i.e., a value related to a shape, property, or the like) with respect to a powdery substance (specifically, toner core particle, toner base particle, external additive, toner, or the like) is given as a number average of values obtained respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (“LA-750,” produced by Horiba Ltd.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Wherever the name of a compound has “-based” appended to it in the name of a polymer, the repeating unit in the polymer is derived from any of that compound and their derivatives. The term “(meth)acrylic” is occasionally used to refer to “acrylic” and “methacrylic” collectively. The term “(meth)acryloyl is occasionally used to refer to “acryloyl” (CH₂═CH—CO—) and “methacryloyl” (CH₂—C(CH₃)—CO—) collectively.

Toner according to the embodiment can be used as positively chargeable toner suitably for development of electrostatic latent images. The toner according to the embodiment is a powdery substance containing a plurality of toner particles (each configured as described later). The toner contains a magnetic powder and is used as one-component developer.

The toner particles of the toner according to the embodiment have a toner base particle and an external additive attached to the surface of the toner base particle. Here, the toner particle before the external additive is attached to it is referred to as the toner base particle. If the toner base particle has a shell layer, the particle before the shell layer is formed on it is referred to as the toner core particle. If the toner base particle has no shell layer, the toner base particle alone is also referred to as the toner core particle.

The toner according to the embodiment can be used, for example, to form an image on an electrophotographic apparatus (image forming apparatus). One example of an image formation method on an electrophotographic apparatus will be described below.

First, based on image data, an electrostatic latent image is formed on a photosensitive member (e.g., in a superficial part of a photosensitive drum). Next, the formed electrostatic latent image is developed with magnetic one-component toner. In the development process, toner (e.g., toner electrostatically charged by friction with a blade) on a development sleeve (e.g., a superficial part of a development roller in a developing device) disposed near the photosensitive member is attached to the electrostatic latent image to form a toner image on the photosensitive member. In the subsequent transfer process, the toner image on the photosensitive member is transferred directly to a recording medium (e.g., paper); or it is first primarily transferred to an intermediate transfer member (e.g., transfer belt) and then the toner image on the intermediate transfer member is secondarily transferred to a recording medium. After that, the toner is heated so that the toner is fixed to the recording medium. In this way, an image is formed on the recording medium.

### [Basic Configuration of Toner]

The magnetic one-component toner according to the present disclosure (hereinafter also referred to simply as the toner) has a toner base particle and an external additive attached to the surface of the toner base particle. The toner base particle at least contains a binder resin, a magnetic powder, and a release agent. The release agent contains a long-chain fatty acid with a carbon number of 24 or more. As necessary, the toner base particle can also contain, in the binder resin, a colorant, a charge control agent, and the like.

The toner according to the present disclosure is configured as follows: it contains, inside the toner base particle, a release agent containing a long-chain fatty acid with a carbon number of 24 or more, and uses, as the external additive attached to the surface of the toner base particle, positively chargeable dry silica particles along with wet silica particles of which the surface has been subjected to positive chargeability treatment and negative chargeability treatment. Used as the wet silica particle is a precipitated silica base material with a high dielectric constant that has been treated with a positively chargeable aminosilane, which increases the dielectric constant, and a negatively chargeable aminosilane, which cancels its variation with time.

### [2. Material of Toner]

Now, a description will be given, one by one, of the binder resin, the magnetic powder, the release agent, the charge control agent, and the colorant that constitute the toner base particle, the silica particles that constitute the external additive externally added to the toner base particle, and a method for producing the toner according to the present disclosure.

### (Binder Resin)

The toner base particle that constitutes the toner according to the present disclosure contains a binder resin. The binder resin that can be contained in the toner base particle is not particularly limited and can be any of binder resins known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, from the viewpoints of the dispersion properties of the colorant in the binder resin, the charging properties of the toner, and the fixing properties on sheets, preferably, at least one of a polyester resin and a styrene-acrylic-based resin is used, more preferred being a polyester resin. The polyester resin will be described below.

Usable as polyester resins are those obtained by condensation polymerization or condensation copolymerization of a dihydric or a trihydric or higher alcohol component and a divalent or a trivalent or higher carboxylic acid component. Examples of components used to synthesize a polyester resin include alcohol components and carboxylic acid components as mentioned below.

Specific examples of dihydric or trihydric or higher alcohol components include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropane triol, 2-methyl-1,2,4-butanetriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylenecarboxypropane, 1,2,4-cyclohexane tricarboxylic acid, tetra(methylene carboxyl)methane, 1,2,7,8-octane tetracarboxylic acid, pyromellitic acid, and empole trimer acid. These divalent or trivalent or higher carboxylic acid components can be used as ester-forming derivatives such as acid halides, acid anhydrides, and lower alkyl esters. Here, the term “lower alkyl” denotes an alkyl group with one to six carbon atoms.

When the binder resin is a polyester-based resin, the softening point of the polyester-based resin is preferably 70° C. or more but 130° C. or less, and more preferably 80° C. or more but 120° C. or less. For improved mechanical strength of the toner base particle and improved fixing properties of the toner, the number average molecular weight (Mn) of the polyester resin is preferably 1000 or more but 2000 or less. The molecular weight distribution of the polyester resin (the ratio Mw/Mn of the mass average molecular weight (Mw) of the polyester resin to its number average molecular weight (Mn)) is preferably 9 or more but 21 or less.

As the binder resin, it is preferable to use a thermoplastic resin for its satisfactory fixing properties on sheets. Here, a thermoplastic resin can be used not only singly but also with a cross-linking agent or a thermosetting resin added to it. Adding a cross-linking agent or a thermosetting resin so that the binder resin partly have a cross-linked structure helps improve the heat-resistant preservation properties, durability, and the like of the toner without degrading the fixing properties of the toner. When a thermosetting resin is used, the cross-linked fraction (gel fraction) of the binder resin extracted using a Soxhlet extractor is preferably, relative to the mass of the binder resin, 10 mass % or less, and more preferably 0.1 mass % or more but 10 mass % or less.

As a thermosetting resin useable with a thermoplastic resin, an epoxy resin or a cyanate-based resin is preferred. Specific examples of suitable thermosetting resins include bisphenol A-type epoxy resins, hydrogenated bisphenol A-type epoxy resins, novolak-type epoxy resins, polyalkylene ether-type epoxy resins, cyclic aliphatic compound-type epoxy resins, and cyanate resins. Two or more of these thermosetting resins can be used in combination.

The glass transition point (Tg) of the binder resin is preferably 40° C. or more but 70° C. or less. Too high a glass transition point tends to lead to poor low-temperature fixing properties of the toner. Too low a glass transition point tends to lead to poor heat-resistant preservation properties of the toner.

The glass transition point of the binder resin can be determined from the changing point of the specific heat of the binder resin using a differential scanning calorimeter (DSC). More specifically, the glass transition point of the binder resin can be determined by drawing the endothermic curve of the binder resin using as a measuring instrument a differential scanning calorimeter (“DSC-6200” produced by Seiko Instruments Inc.). 10 mg of a measurement sample is put in an aluminum pan, while a vacant aluminum pan is used as a reference. From the endothermic curve of the binder resin drawn through measurement in a normal-temperature normal-humidity environment in the range of measurement temperature from 25° C. to 200° C. at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polyethylene resin.

### (Magnetic Powder)

The toner base particle contains a magnetic powder in the binder resin. Suitably usable as a material of the magnetic powder is, for example, a ferromagnetic metal (more specifically, iron, cobalt, nickel, an alloy of one or more of these metals, or the like), a ferromagnetic metal oxide (more specifically, ferrite, magnetite, chromium dioxide, or the like), or a material subjected to ferromagnetization (more specifically, a carbon material made ferromagnetic by heat treatment, or the like). To suppress the elution of a metal ion (e.g., iron ion) from the magnetic powder, preferably, surface-treated magnetic particles are used as the magnetic powder. One type of magnetic powder can be used singly or a plurality of types of magnetic powder can be used in combination.

The particle size of the magnetic powder is not limited within the scope consistent with the object of the present disclosure. Specifically, the particle size of the magnetic powder is preferably 0.1 μm or more but 1.0 μm or less, and more preferably 0.1 μm or more but 0.5 μm or less. Using a magnetic powder with a particle size in those ranges makes it easy to disperse the magnetic powder in the binder resin.

As the magnetic powder, it is possible to use a product surface-treated using a surface treatment agent such as a titanium-based coupling agent or silane-based coupling agent for the purpose of improving the dispersion properties of the magnetic powder in the binder resin.

The amount of magnetic powder used is not particularly limited within the scope consistent with the object of the present disclosure. Specifically, the amount of magnetic powder used is preferably, relative to the total mass of the toner, 30 mass % or more but 60 mass % or less, and more preferably 40 mass % or more but 60 mass % or less. Using too large an amount of magnetic powder can make it difficult to form images with the desired image density for a long period, or can lead to extremely poor fixing properties of the toner on sheets. Using too small an amount of magnetic powder can cause fogging in the formed image, or can make it difficult to form images with the desired image density for a long period.

### (Release Agent)

For the purpose of improving its fixing properties and anti-offsetting properties, the toner base particle contains a release agent. The release agent contains a long-chain fatty acid with a carbon number of 24 or more. The type of release agent that can be added to the toner base particle is not limited so long as it contains a long-chain fatty acid with a carbon number of 24 or more. As such a release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding such a release agent to the toner base particle helps more effectively suppress offsetting and image smearing (stain around an image caused by its being rubbed).

When polyester resin is used as the binder resin, from the viewpoint of compatibility, as the release agent, one or more release agents selected from the group consisting of carnauba wax, synthetic ester wax, and polyethylene wax are suitably used. When a polystyrene-based resin is used as the binder resin, likewise from the viewpoint of compatibility, as the release agent, Fischer-Tropsch wax and/or paraffin wax is suitably used.

Fischer-Tropsch wax is a straight-chain hydrocarbon compound with few iso-structure molecules or side chains that is produced by exploiting the Fischer-Tropsch reaction, which is a catalytic hydrogenation reaction of oxygen monoxide.

Preferred among different types of Fischer-Tropsch wax are those that have a mass average molecular weight of 1,000 or more and of which the bottom temperature of the exothermal peak observed by DSC measurement falls within the range of 100° C. or more but 120° C. or less. Examples of such types of Fischer-Tropsch wax include the following products available from Sasol: Sasol Wax C1 (exothermic peak bottom temperature: 106.5° C.), Sasol Wax C105 (exothermic peak bottom temperature: 102.1° C.), and Sasol Wax Spray (exothermic peak bottom temperature: 102.1° C.).

The amount of release agent used is not particularly limited within the scope consistent with the object of the present disclosure. Specifically, the amount of release agent used is preferably, relative to the total mass of the toner base particle, 1 mass % or more but 10 mass % or less. Using too small an amount of release agent can result in insufficient suppression of offsetting and image smearing in image formation; using too large an amount of release agent can result in fusing-together of toner particles and hence poor heat-resistant preservation properties of the toner.

### (Colorant)

Containing a magnetic powder as an essential component, the toner base particle is generally black. Accordingly, within the scope consistent with the object of the present disclosure, for the purpose of obtaining a more preferred tone of black in the image formed using the toner of the present disclosure, the toner can contain as a colorant any known dye or pigment. Specifically, one example of a pigment is carbon black and one example of a dye is an acid violet.

The amount of colorant used is not particularly limited within the scope consistent with the object of the present disclosure. Specifically, the amount of colorant used is preferably, relative to the total mass of the toner, 1 mass % or more but 10 mass % or less, and more preferably 2 mass % or more but 7 mass % or less.

A colorant can be used as a master batch having a colorant previously dispersed in a resin material such as a thermoplastic resin. When a colorant is used as a master batch, the resin contained in the master batch is preferably a resin of the same type as the binder resin.

### (Charge Control Agent)

The toner base particle can contain a charge control agent for the purpose of improving the charge level of the toner and its charge response properties as an index of whether it can be charged to a predetermined charge level in a short time and thereby obtaining toner with excellent durability and stability. Since the toner according to the present disclosure is positively chargeable toner, a positively chargeable charge control agent is used.

The type of charge control agent that can be contained in the toner core particle is not particularly limited within the scope consistent with the object of the present disclosure. Any of charge control agents known to be used in toner can be appropriately selected and used. Specific examples of positively chargeable charge control agents include azine compounds such as pyridazine, pyrimidine, pyrazine, orthoxazine, metaoxazine, paraoxiazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes composed of azine compounds, such as azine fast red FC, azine fast red 12BK, azine violet BO, azine brown 3G, azine light brown GR, azine dark green BH/C, azine deep black EW, and azine deep black 3RL; nigrosine compounds such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; triphenylmethane-based dyes; alkoxylated amines; alkylamides; and quaternary ammonium salts such as benzylmethylhexyldecylammonium and decyltrimethylammonium chloride. Among these positively chargeable charge control agents, nigrosine compounds are particularly preferred for their faster charge response properties. Among these positively chargeable charge control agents, two or more types can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins is not particularly limited within the scope consistent with the object of the present disclosure, and they can be in the form of an oligomer or a polymer.

Among resins usable as a positively chargeable charge control agent, from the viewpoint of easy adjustment of charge amount within a desired range, styrene-acrylic-based resin having as a functional group a quaternary ammonium salt is more preferred. In styrene-acrylic-based resins having as a functional group a quaternary ammonium salt, specific examples of preferred acrylic-based comonomers for copolymerization with the styrene unit include esters of alkyl (meth)acrylates such as methyl acrylate, ethyl acrylate, n-propyl acrylate, isopropyl acrylate, n-butyl acrylate, isobutyl acrylate, 2-ethylhexyl acrylate, methyl methacrylate, ethyl methacrylate, n-butyl methacrylate, and isobutyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acryl amide include dimethyl methacryl amide. Specific examples of dialkyl aminoalkyl (meth)acryl amide include dimethyl aminopropyl methacryl amide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The amount of charge control agent used is not particularly limited within the scope consistent with the object of the present disclosure. Typically, the amount of charge control agent used is preferably, relative to the total mass of the toner core particle, 0.1 mass % or more but 10 mass % or less. Using too small an amount of charge control agent makes it difficult to stably charge the toner with a predetermined polarity. This can lead to a lower-than-expected image density in the formed image and make it difficult to maintain satisfactory image density for a long period. Also the charge control agent is then difficult to disperse evenly, and this tends to cause fogging in the formed image and contamination of a latent image carrying member with toner components. Using too large an amount of charge control agent leads to poorer resistance to environment, resulting in image faults in the formed image due to insufficient charging under high temperature and high humidity and contamination of a latent image carrying member with toner components.

The toner base particle can be a toner base particle with no shell layer (non-capsule toner base particle) or a toner base particle with a shell layer (capsule toner base particle). A capsule toner base particle can be produced by forming a shell layer on the surface of a non-capsule toner base particle (toner core particle). The shell layer can be formed substantially solely of a thermosetting resin, can be formed substantially solely of a thermoplastic resin, or can contain both a thermoplastic resin and a thermosetting resin.

### (External Additive)

The toner according to the present disclosure has a toner base particle of which the surface is treated with an external additive. The toner according to the present disclosure contains, as the external additive, dry silica and wet silica.

### (Dry Silica Particles)

Dry silica particles have few silanol groups and thus provide a large charge amount. They are produced, for example, by a process of subjecting a silane halide such as silicon tetrachloride to gas-phase hydrolysis at high temperature (flame hydrolysis process) or a process of vaporizing silica sand by reducing it with coke in an electric furnace and then oxidizing the produced gas (heating process). Typically used as dry silica particles are those surface-treated with a hydrophobization agent such as an alkylsilane. Specific examples of alkylsilanes include alkylhalosilanes (more specifically, trichloro(methyl)silane, dichlorodimethylsilane, chlorotrimethylsilane, tert-butyldimethylchlorosilane, and the like), phenylhalosilanes (more specifically, phenyltrichlorosilane, dichlorodiphenylsilane, and the like), vinylhalosinales (more specifically, vinyltrichlorosilane and the like), tetraalkoxysilanes (more specifically, tetramethoxysilane, tetraetoxysilane, and the like), alkylalkoxysilanes (more specifically, trimetoxy(methyl)silane, dimethoxydimethylsilane, triethoxymethylsilane, diethoxydimethylsilane, isobutyltrimethoxysilane, decyltrimethoxysilane, and the like), alkylalkoxysilane halides (more specifically, 3-chloropropyltrimethoxysilane and the like), phenylalkoxysilanes (more specifically, trimethoxyphenylsilane, dimethoxydiphenylsilane, triethoxyphenylsinalne, diphenyldiethoxysilane, and the like), vinyalkoxysilanes (more specifically, vinyltrimethoxysilane, vinyltriethoxysilane, and the like), silane coupling agents having a (meth)acryloyl group (more specifically, 3-(trimethoxysilyl) propyl methacrylate and the like), silane coupling agents having an epoxy group (more specifically, 2-(3,4-epoxycyclohexyl)ethyltrimethoxysilane, 3-glycidyloxypropyltrimethoxysilane, 3-glycidyloxypropylmethyldiethoxysilane, and the like), and silane coupling agents having a mercapto group (more specifically, 3-mercaptopropyltrimethoxysilane and the like). Using dry silica particles hydrophobized with a positively chargeable hydrophobization agent such as an aminosilane, which has an amino group introduced in a silane compound helps enhance the positive chargeability of the dry silica particles and makes it easy to suppress a drop in the charge amount of the toner under high-temperature high-humidity conditions.

Silicone oil can also be used as a hydrophobization agent for dry silica particles. The type of silicone oil is not particularly limited so long as it provides the desired hydrophobizing effect and any of various silicone oils known to be used as a hydrophobization agent can be used. Silicone oil having a straight-chain siloxane structure is preferred, and both non-reactive and reactive silicone oil can be used. Specific examples of silicone oil include dimethylsilicone oil, phenylmethylsilicone oil, chlorophenylsilicone oil, alkylsilicone oil, chlorosilicone oil, polyoxyalkylene-modified silicone oil, fatty acid ester-modified silicone oil, methylhydrogen silicone oil, silanol group-containing silicone oil, alkoxy group-containing silicone oil, acetoxy group-containing silicone oil, amino-modified silicone oil, carboxylic acid-modified silicone oil, and alcohol-modified silicone oil.

The dry silica particles can be hydrophobized, for example, by a method involving, while stirring dry silica particles at high speed, dropping or spraying a hydrophobization agent such as an alkylsilane, amonosilane, or silicone oil, or by a method involving adding silica particles to a solution of a hydrophobization agent in an organic solvent while stirring the latter. Heating after hydrophobization yields hydrophobized dry silica particles. When the hydrophobization agent is dropped or sprayed, it can be used as it is or in a form diluted with an organic solvent.

The average particle size of the dry silica particles is preferably 10 nm or more but 150 nm or less. The amount of dry silica particles added is preferably, relative to the mass of the toner base particle, 0.8 mass % or more but 1.6 mass % or less, and more preferably 0.8 mass % or more but 1.4 mass % or less. Keeping the amount of dry silica particles added in those ranges, among others, makes it easy to suppress fogging in images resulting from the toner receiving mechanical stress in a developer container.

### (Wet Silica Particles)

Wet silica particles are produced, for example, by a method that synthesizes silica fine particles in wet form through hydrolysis of an alkoxysilane or a method like a precipitation process or a sol-gel process that produces silica fine particles in wet form from sodium silicate. Wet silica is obtained in a form of primary particles secondarily agglomerated, and do not provide satisfactory fluidity.

As with dry silica, the surface of wet silica particles is hydrophobized with a hydrophobization agent such as an alkylsilane, an aminosilane having an amino group introduced in an alkylsilane, or silicone oil. The wet silica particles can be hydrophobized by methods similar to those for dry silica. The wet silica particles can be surface-treated with a negatively chargeable silane. Examples of negatively chargeable silanes include fluorine-containing silanes such as trimethoxy(3,3,3-trifluoropropyl)silane.

The average particle size of wet silica particles is preferably 10 nm or more but 150 nm or less. The amount of wet silica particles added is preferably, relative to the mass of the toner base particle, 0.2 mass % or more but 0.4 mass % or less, and more preferably 0.2 mass % or more but 0.3 mass % or less. Keeping the amount of wet silica particles added in those ranges, among others, makes it easy to suppress fogging in images resulting from the toner receiving mechanical stress in a developer container. It is then also easy to obtain toner of which the rate of change of the fluidity is 5% or less.

The external additive can contain, in addition to dry silica particles and wet silica particles, any external additive other than silica particles. Preferred as another external additive is particles of a metal oxide (more specifically alumina, titanium oxide, magnesium oxide, zinc oxide, strontium titanate, or barium titanate) or resin particles. The other external additive can be surface-treated. The average particle size of the other external additive is not particularly limited within the scope consistent with the object of the present disclosure and is preferably 0.01 μm or more but 1.0 μm or less.

### [Method for Producing the Toner]

Next, a production method for the toner according to the present disclosure will be described. The production method for the toner includes a production method for a toner base particle and an external additive treatment method for attaching an external additive to the surface of the toner base particle. The production method for the toner base particle is not particularly limited so long as it forms the toner base particle with a predetermined structure. As a production method suitable for the positively chargeable toner described above, a production method for the toner base particle and an external additive treatment method will be described one by one.

### (Production Method for the Toner Base Particle)

The method for producing the toner base particle is not particularly limited so long as it can satisfactorily disperse a magnetic powder and any components such as a colorant, a release agent, and a charge control agent in a binder resin. Examples of suitable production methods for the toner base particle include a pulverization process and an agglomeration process.

In a pulverization process, the binder resin is mixed with the components such as the magnetic powder, colorant, release agent, and charge control agent using a mixer or the like; then the binder resin and the components blended in it are melted and kneaded using a kneader such as a uniaxial or biaxial extruder; and then the cooled kneaded product is pulverized and classified. The average particle size of the toner core particle is not particularly limited within the scope consistent with the object of the present disclosure; typically, it is preferably 5 μm or more but 10 μm or less.

In an agglomeration process, in an aqueous solvent containing fine particles of each of the binder resin, magnetic powder, colorant, release agent, charge control agent, and the like, those fine particles are agglomerated until they form particles of the desired particle size. This produces agglomerated particles containing the binder resin, release agent, charge control agent, and colorant. Subsequently, the obtained agglomerated particles are heated so that the components of the agglomerated particles coalesce. In this way, a toner core particle with the desired particle size is obtained.

### (External Additive Treatment Method)

The method for treating the toner base particle with the external additive is not particularly limited; the toner base particle can be treated by any known method. Specifically, the toner base particle is treated with the external additive using a mixer such as a Henschel mixer or Nauta mixer under treatment conditions adjusted so that the particles of the external additive do not sink into the toner base particle.

### [3. Charge Amount Distribution of Toner]

Next, a method for determining the charge amount distribution of the toner according to the present disclosure will be described. In the present disclosure, the following method is used to express in a simple manner the charge amount distribution in a toner chain. Toner and carrier are mixed together at a toner concentration (T/C; the proportion of the mass of toner to the mass of carrier) equal to or higher than that corresponding to the amount of toner that can coat 100% of the surface of the carrier, and the change of carrier charge amount versus T/C is measured as a surrogate indicator.

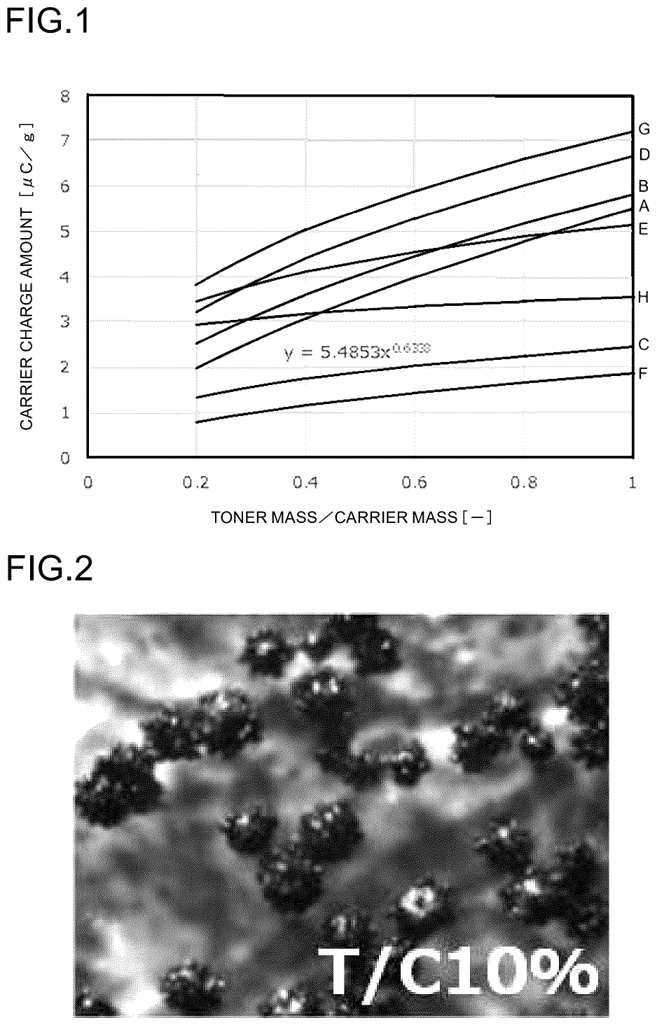

FIG. 1 is a graph showing the relationship between carrier charge amount and toner concentration (T/C). FIG. 1 results from, with eight types of toner A to H produced as the practical examples described later, loading a plastic vessel with a volume of 10 cc with 10 g of standard carrier P-01 (distributed by the Image Society of Japan); then adding one of toners A to H such that the mass mixture ratio (i.e., T/C) of the toner was 0.2, 0.4, 0.6, 0.8, and 1.0; then mixing the mixture for 10 minutes using a Turbula Shaker-Mixer (produced by Shinmaru Enterprises Corporation); and then measuring and plotting the carrier charge amount. The carrier charge amount was measured using a charge amount measurement device (Q/m meter, Model 210HS, produced by Trek Inc.). Since the toner is positively chargeable, the carrier charge amount is a negative (minus) value; here, however, it is calculated as a positive (plus) value to obtain an approximation expression, which will be described later.

Standard carrier P-01 is a positively chargeable carrier of which the charge amount is certified so that anyone can measure the charge amount of toner in conformity with the standard toner charge amount measurement method prescribed by the Image Society of Japan.

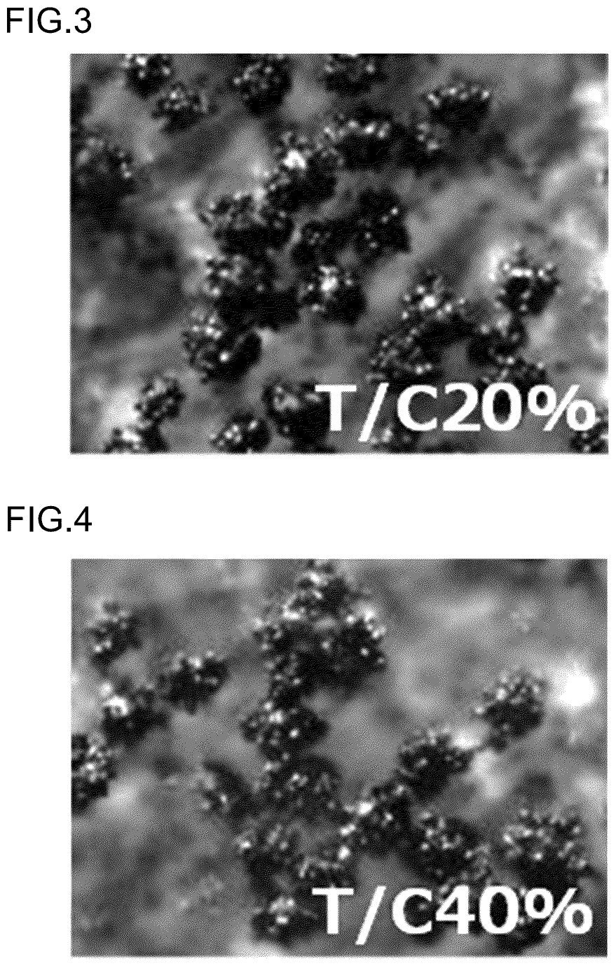

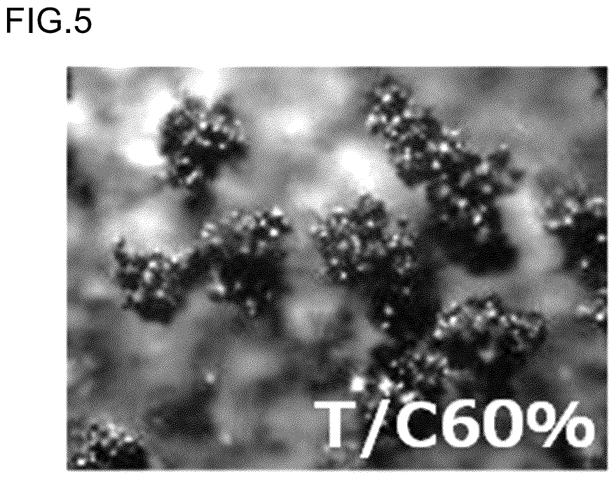

FIGS. 2 to 5 are electron microscope images each showing the condition of toner and carrier mixed together for cases where the toner density (T/C) is 10%, 20%, 40%, and 60% respectively. As shown in FIGS. 2 to 5, under the mirror image force acting among toner particles, as the toner concentration increases, the toner particles conglomerate to a higher degree. That is, it is considered that, at a toner concentration higher than that corresponding to the amount of toner that can coat 100% of the surface of the carrier, the change of the charge amount of carrier depends on the transmissibility among toner particles.

As shown in FIG. 1, the relationship between carrier charge amount and toner charge amount (the I/C dependence of carrier charge amount) has a positive correlation. More specifically, when the mass mixture ratio of toner to carrier is represented by x and the carrier charge amount is represented by y, then they fulfill the relationship given by the approximation expression (1) below.

$$y = b * {x}^{a} \qquad ( 1 )$$

where
a is the rate of change of carrier charge amount relative to toner concentration; and
b is a constant.

The above expression (1) is derived from expressions (2) and (3) below.

$$Ln ( y ) = a * Ln ( x ) + {b}^{′} \qquad ( 2 )$$

$$b = EXP ( {b}^{′} ) \qquad ( 3 )$$

Here, the easier the transmission of electric charge among toner particles, the closer to one the rate of change of carrier charge amount relative to the mass mixture ratio x of toner to carrier (i.e., T/C); if no charging occurs among toner particles, the rate of change of carrier charge amount is zero.

For the toner according to the present disclosure, the charge amount distribution of toner is defined so as to fulfill 0.3≤a≤1 and −7≤b≤−3 (where, x is 0.2, 0.4, 0.6, 0.8, or 1.0) in the approximation expression (1). As will be discussed later in connection with practical examples, this helps maintain image density beyond durability printing and effectively suppress image fogging and disturbances in a toner layer on a development roller.

With the toner according to the present disclosure described above, when images are formed for a long period in various environment such as a high-temperature high-humidity environment and a low-temperature low-humidity environment, it is possible to electrostatically charge the toner with the desired charge amount, and thus to form images with the desired density. It is also possible to effectively suppress image fogging after durability printing and disturbances in the toner layer when the toner is installed in a low-temperature low-humidity environment. Thus, the toner according to the present disclosure can be used suitably in various image forming apparatuses. The effects of the present disclosure will be described more specifically below by way of practical examples. The present disclosure is in no way limited by these practical examples.

### EXAMPLES

### Production Example 1

### (Production of Toner Base Particles)

As a binder resin, 1984 g of polyester resin (Tufton NE-8000, produced by Kao Corporation; a mixture of three types of resin) and 60 g of polyester resin (KD-C8, produced by Kao Corporation) were mixed with 1600 g of a magnetic powder (MRO-15A, produced by Toda Kogyo Corporation; resistance value: 200 (2·m), 200 g of a charge control agent (FCA-482PLV, produced by Fujikura Kasei Co., Ltd.), and, as a release agent, 120 g of montan wax (WARADUR_S, produced by Voelpker) for five minutes at a rotation rate of 2000 rpm using an FM mixer (MF-20B, manufactured by Nippon Coke & Engineering Co., Ltd.) to obtain a mixture.

The obtained mixture was melted and kneaded using a biaxial extruder (TEM-26SS, produced by Toshiba Machine Co., Ltd.) to obtain a kneaded product. The melting and kneading were performed under the conditions of a cylinder temperature of 120° C., a spindle rotation rate of 100 rpm, and a processing rate of 90 g/min. The kneaded product was cooled and was then coarsely pulverized using a pulverizer (Rotoplex 16/8, produced by Hosokawa Micron Corporation). The obtained coarsely pulverized product was then pulverized using a mechanical pulverizer (Turbomill TA, produced by Freund-Turbo Corporation) to obtain a pulverized product. The pulverized product was finely pulverized and classified using a pulverizer-classifier (Jet Mill MJT-1, produced by Hosokawa Micron Corporation) to obtain toner base particles A containing a long-chain fatty acid with a carbon number of 24 or more.

Instead of montan wax, ester wax (WEP-3, produced by NOF Corporation) was added to produce, through a similar procedure to toner base particles A, toner base particles B that does not contain a long-chain fatty acid with a carbon number of 24 or more.

### Production Example 2

### (Production of Wet Silica Particles)

In a jacketed reaction vessel of stainless steel with a volume of 20 L provided with a stirrer, two dropping nozzles, and a thermometer as well as with a circulation pump, 10 L of a 50 mass % aqueous solution of sodium silicate No. 3 (SiO₂ concentration: 25 mass %, SiO₂/Na₂O mol ratio: 3.3) and a 40 mass % aqueous solution of sulfuric acid were mixed such that the excess sulfuric acid was 0.6N to obtain silica hydrosol. The silica hydrosol was left to stand still for a while to turn into gel. The product was hydrothermally processed for 12 hours under the conditions of 90° C. and a pH value of 9.5; then, to remove alkalis, sulfuric acid was added until the excess sulfuric acid was 0.03N. The product was then left to stand still for another one hour at 60° C. After that, the product was washed with water sufficiently to obtain pure silica hydrogel.

The obtained silica hydrogel was dried using a dryer until its moisture content was 10%, was then pulverized on a jet mill using superheated steam (PJM-100NP, produced by Nippon Pneumatic Mfg. Co., Ltd.), and was classified using a wind-power classifier. The obtained product was filtered using a filter press and washed with water to obtain a silica cake. The obtained silica cake was turned into a slurry using a reciprocating rotary stirrer (Ajiter AP04, produced by Shimazaki Mixing Engineering Co., Ltd.). Then, to the silica, 2.0 mass % of polyoxyalkylenealkyl ether nonionic surfactant (Noigen XL-61, produced by DKS Co., Ltd.; HLB: 13) was added. The product was restirred, was then spray-dried under the condition of an outlet temperature of 110° C. using a disc-type spray dryer (Spray Dryer AN-40R, produced by Ashizawa Niroatomizer. Co.), was then pulverized using a jet mill (PJM-100NP, produced by Nippon Pneumatic Mfg. Co., Ltd.), and was classified using a wind-power classifier (Classeal N-5 produced by Seishin Enterprise Co., Ltd.) to remove coarse particles to obtain 1.2 kg of silica base material.

Subsequently, 100 g of the obtained silica base material was put in a jacketed reaction vessel of stainless steel with a volume of IL provided with a stirrer and a thermometer. While into this reaction vessel a 10-times diluted solution in 50 g of toluene of, as surface treatment agent 1 (positively chargeable surfactant), 5 g of N-2-(aminoethyl)-3-aminopropylmethyldimethoxysilane and, as surface treatment agent 2 (negatively chargeable surfactant), 5 g of trimethoxy(3,3,3-trifluoropropyl)silane (both produced by Shin-Etsu Chemical Co., Ltd.) was dropped little by little under stirring, these were subjected to ultrasonic irradiation for 30 minutes to obtain a mixture. This mixture was heated in a constant-temperature bath at 150° C. and then, using a rotary evaporator, the toluene was distilled out. Then, a solid product obtained using a reduced-pressure dryer was dried at a set temperature of 50° until its weight no longer reduced. The product was then heated for three hours at 200° C. under a stream of nitrogen in an electric furnace. The obtained powdery substance was pulverized using a jet mill (PJM-100NP, produced by Nippon Pneumatic Mfg. Co., Ltd.) and was collected in a bag filter to obtain silica particles A.

As surface treatment agent 2, instead of 5 g of trimethoxy(3,3,3-trifluoropropyl)silane, 10 g of isopropyl titanium triisostearate (produced by Ajinomoto Fine-Techno Co., Inc.) was used to obtain, through an otherwise similar procedure to silica particles A, silica particles B.

As surface treatment agent 1, instead of 5 g of N-2-(aminoethyl)-3-aminopropylmethyldimethoxysilane, 5 g of 3-aminopropyltriethoxysilane (produced by Shin-Etsu Chemical Co., Ltd.) was used to obtain, through an otherwise similar procedure to silica particles A, silica particles C.

Without use, as surface treatment agent 2, of 5 g of trimethoxy(3,3,3-trifluoropropyl)silane, through an otherwise similar procedure to silica particles C, silica particles D was obtained.

### Production Example 3

### (Production of Dry Silica Particles)

A silicon tetrachloride compound was along with nitrogen gas introduced into a mixing chamber of a combustion apparatus (burner). Then, hydrogen and air were additionally introduced into the mixing chamber and all the gases so introduced were reacted by combustion under the condition of 1200° C. in a reaction chamber of the combustion apparatus. After that, the reaction product was collected using a filter with a pore size of 1 μm at a combustion exhaust gas temperature of 450° C.

100 g of the obtained solid substance was put in a reaction vessel and nitrogen gas was introduced into it to create a nitrogen atmosphere. Subsequently, the solid substance in the reaction vessel was sprayed with a surface treatment liquid containing 15 g of 3-aminopropyltriethoxysilane, 15 g of hexamethyldisilazane, and 1 g of water. Then, the temperature inside the reaction vessel was raised to 200° C. and the contents were stirred for two hours in the nitrogen atmosphere. Furthermore, the contents were heated for three hours under stirring at 250° C. in the nitrogen atmosphere to be dried. The contents were then cooled to obtain silica particles E.

### Production Example 4

### (Production of Toner)

1.8 kg of toner base particles A obtained in Production Example 1, 4 g of silica particles A obtained in Production Example 2, and 8 g of silica particles E obtained in Production Example 3 were mixed for 15 minutes at a rotation rate of 2120 rpm using an FM mixer (MF-10C, manufactured by Nippon Coke & Engineering Co., Ltd.) to attach (externally add) silica particles A and E to the toner base particles A. After that, the product was sieved using a sieve of 100 mesh (with a mesh size of 150 μm) to obtain toner A of Practical Example 1 according to the present disclosure.

Except that the types of wet silica particles and dry silica particles used and their amounts added were changed, by an otherwise similar procedure to the toner of Practical Example 1, toners B to D of Practical Examples 2 to 4 according to the present disclosure and toners E to H of Comparative Examples 1 to 4 were obtained. For each of toners A to D of Practical Examples 1 to 4 and toners E to H of Comparative Examples 1 to 4 mixed with carrier P0-1, the carrier charge amount and the coefficients in the relational expression are shown, along with the composition of the toner, in Table 1.

TABLE 1

| | | | | | | | | | | Toner Composition | | | | | |
|---|---|---|---|---|---|---|---|---|---|---|---|---|---|---|---|
| | | | | | | | | | | | Long- | Wet Silica | | | |
| | | Carrier Charge Amount | | | | | | | | Toner | Chain | | Surface | Surface | |
| | | Approxiimation Expression | | | T/C | | | | | Base | Fatty | | Treatment | Treatment | Dry |
| | Toner | a | b′ | b | 0.2 | 0.4 | 0.6 | 0.8 | 1.0 | Particle | Acid | Type | Agent 1 | Agent 2 | Silica |
| Practical | A | 0.634 | 1.702 | −5.49 | −2.02 | −3.03 | −3.75 | −4.93 | −5.57 | A | Yes | A | N-2AE- | TM(TFP)S² | Yes |
| Example 1 | | | | | | | | | | | | | 3APMDS¹ | | |
| Practical | B | 0.523 | 1.760 | −5.81 | −2.52 | −3.61 | −4.26 | −5.36 | −5.8 | A | Yes | B | N-2AE- | TISIPS³ | Yes |
| Example 2 | | | | | | | | | | | | | 3APMDS | | |
| Practical | C | 0.383 | 0.896 | −2.45 | −1.32 | −1.76 | −1.98 | −2.14 | −2.57 | B | No | A | N-2AE- | TM(TFP)S | Yes |
| Example 3 | | | | | | | | | | | | | 3APMDS | | |
| Practical | D | 0.452 | 1.894 | −6.65 | −3.10 | −4.56 | −5.50 | −6.10 | −6.28 | A | Yes | C | 3-APTES⁴ | TM(TFP)S | Yes |
| Example 4 | | | | | | | | | | | | | | | |
| Comparative | E | 0.249 | 1.639 | −5.15 | −3.32 | −4.26 | −4.74 | −4.90 | −4.88 | A | Yes | No | | | Yes |
| Example 1 | | | | | | | | | | | | | | | |
| Comparative | F | 0.539 | 0.619 | −1.86 | −0.78 | −1.14 | −1.36 | −1.71 | −1.84 | A | Yes | C | 3-APTES | TM(TFP)S | No |
| Example 2 | | | | | | | | | | | | | | | |
| Comparative | G | 0.395 | 1.973 | −7.19 | −3.75 | −5.13 | −5.79 | −6.85 | −6.95 | A | Yes | D | 3-APTES | — | No |
| Example 3 | | | | | | | | | | | | | | | |
| Comparative | H | 0.117 | 1.262 | −3.53 | −2.98 | −3.03 | −3.42 | −3.49 | −3.50 | B | No | No | | | Yes |
| Example 4 | | | | | | | | | | | | | | | |

1. N-2-(aminoethyl)-3-aminopropylmethyldimethoxysilane.
2. Trimethoxy (3,3,3-trifluoropropyl)silane.
3. Isopropyl titanium triisostearate
4. 3-Aminopropyltriethoxysilane

### [Evaluation of Image Fogging and Disturbances in a Toner Layer on a Development Roller]

For each of the toners of Practical Examples 1 to 4 and the toners of Comparative Examples 1 to 4, the image density, the image fogging, and the disturbances in the toner layer on the developing roller as observed when it was used were evaluated by the methods described below.

### (Image Density)

The toners of Practical Examples 1 to 4 and Comparative Examples 1 to 4 obtained in Production Example 4 were each installed in the developing portion of an evaluation machine (a monochrome printer ECOSYS PA6000x, produced by Kyocera Document Solutions). After the installation of the toner, a test image with a coverage ratio of 2% was printed by three-sheet intermittent output on 100,000 sheets in a normal-temperature normal-humidity environment (NN environment, temperature: 23° C., humidity: 65% RH), then on 10,000 sheets in a high-temperature high-humidity environment (HH environment, temperature: 28° C., humidity: 80% RH), and then on 10,000 sheets in a low-temperature low-humidity environment (LL environment, temperature: 10° C., humidity: 20% RH). Meanwhile, immediately after the start of printing (at the outset), after 100,000-sheet printing in the NN environment, after 10,000-sheet printing in the HH environment, and after 10,000-sheet printing in the LL environment, the image density (ID) was measured using a reflection density meter (TC-6DX, produced by Tokyo Denshoku Co., Ltd.). The criteria for evaluation of the image density were as follows:
Good: ID≥1.2 (quite good, practically acceptable)
Fair: 1.0≤ID<1.2 (good enough, practically acceptable)
Poor: ID<1.0 (poor, practically unacceptable)

### (Image Fogging)

In the print results after 100,000-sheet printing in the NN environment, the fog density (FD) in the blank background around the image was measured using a reflection density meter (TC-6DX, produced by Tokyo Denshoku Co., Ltd.). The fog density (FD) was calculated according to Expression (1) below.

$$FD = ( Reflection Density in Blank Part on Printed Sheet ) - ( Reflection Density of Unprinted Sheet )$$

The criteria for evaluation of the image density were as follows:
Good: FD<0.01 (practically acceptable)
Poor: FD≥0.01 (practically unacceptable)

### (Disturbances in the Toner Layer on the Development Roller)

The disturbances in the toner layer on the development roller after the installation of the toner in the LL environment was evaluated by visual inspection. The criteria for evaluation of the disturbances in the toner layer were as follows:
Good: No disturbances in the toner layer (practically acceptable)
Poor: Disturbances in the toner layer observed (practically unacceptable)

The results of evaluation of the image density, the image fogging, and the disturbances in the toner layer on the development roller as observed when the toners of Practical Examples 1 to 4 and Comparative Examples 1 to 4 were used are shown in Table 2. The values in Table 2 are the measured values of image density (ID) and fog density (FD).

TABLE 2

| | Image Density (ID) | | | | Image Fogging | Toner Layer |
|---|---|---|---|---|---|---|
| | | NN | HH | LL | NN | Disturbances |
| | NN | Environment, | Environment, | Environment, | Environment, | LL Environment, |
| | Environment, | After 100,000- | After 10,000- | After 10,000- | After 100,000- | After Toner |
| Toner | Outset | Sheet Printing | Sheet Printing | Sheet Printing | Sheet Printing | Installation |
| Practical | Good/1.32 | Good/1.36 | Good/1.31 | Good/1.37 | Good/0.003 | Good |
| Example 1 | | | | | | |
| Practical | Good/1.30 | Good/1.34 | Good/1.24 | Good/1.30 | Good/0.005 | Good |
| Example 2 | | | | | | |
| Practical | Good/1.28 | Good/1.28 | Fair/1.12 | Good/1.26 | Good/0.004 | Good |
| Example 3 | | | | | | |
| Practical | Good/1.35 | Good/1.32 | Good/1.26 | Fair/1.03 | Good/0.006 | Good |
| Example 4 | | | | | | |
| Comparative | Good/1.30 | Good/1.35 | Good/1.23 | Good/1.32 | Poor/0.015 | Good |
| Example 1 | | | | | | |
| Comparative | Good/1.29 | Good/1.26 | Poor/0.92 | Good/1.22 | Good/0.005 | Good |
| Example 2 | | | | | | |
| Comparative | Good/1.29 | Good/1.36 | Good/1.11 | — | Good/0.002 | Poor |
| Example 3 | | | | | | |
| Comparative | Good/1.33 | Good/1.31 | Poor/0.99 | Good/1.27 | Poor/0.033 | Good |
| Example 4 | | | | | | |

Table 2 reveals the following. With all of the toners of Practical Examples 1 to 4, which fulfilled 0.3≤a≤1 and −7≤b≤−3 in the approximation expression y=b*x^{a} of carrier charge amount and which contained as an external additive externally added to the surface of the toner base particle both wet and dry silica particles, the image density (ID) was satisfactory, that is, 1.0 or more, on all occasions, that is, at the outset and after 100,000-sheet printing in the NN environment, after 10,000-sheet printing in the HH environment, and after 10,000-sheet printing in the LL environment. Also the fog density (FD) after 100,000-sheet printing in the NN environment was 0.01 or less, that is, no image fogging was observed. Moreover, no disturbances were observed in the toner layer on the development roller after the installation of the toner in the LL environment.

In particular, with both of the toners of Practical Examples 1 and 2, in which the release agent added to the toner base particle contained a long-chain fatty acid with a carbon number of 24 or more and which used as a surface treatment agent for wet silica particles N-2-(aminoethyl)-3-aminopropylmethyldimethoxysilane, the image densities (ID) after 10,000-sheet printing in the HH environment and in the LL environment were excellent, that is, 1.2 or more.

By contrast, with both of the toners of Comparative Examples 1 and 4, which did not fulfill 0.3≤a≤1 and in which as an external additive only dry silica particles were added, the fog density (FD) after 100,000-sheet printing in the NN environment was 0.01 or more, that is, image fogging was observed. In particular, with the toner of Comparative Example 4, in which the release agent added to the toner base particle did not contain a long-chain fatty acid with a carbon number of 24 or more, the image density (ID) after 10,000-sheet printing in the HH environment was less than 1.0, that is, satisfactory image density was not obtained. Also the fog density (FD) was 0.033, that is, notable image fogging was observed.

On the other hand, with the toner of Comparative Example 2, which did not fulfill −7≤b≤−3 and in which as an external additive only wet silica particles surface-treated with 3-aminopropyltriethoxysilane and trimethoxy(3,3,3-trifluoropropyl)silane were added, the image density (ID) after 10,000-sheet printing in the HH environment was less than 1.0, that is, satisfactory image density was not obtained.

With the toner of Comparative Example 3, in which as an external additive only wet silica particles surface-treated with 3-aminopropyltriethoxysilane were added, disturbances were observed in the toner layer on the development roller after the installation of the toner in the LL environment. Accordingly, with the toner of Comparative Example 3, no durable printing was performed in the LL environment.

The above results confirm the following. By fulfilling 0.3≤a≤1 and −7≤b≤−3 in the approximation expression y=b*x^{a} of carrier charge amount and using as the external additive externally added to the surface of the toner base particle both wet silica particles subjected to positive chargeability treatment and treated with a fluorine-containing negatively chargeability surface treatment agent and dry silica particles subjected to positive chargeability treatment, it is possible to obtain magnetic one-component toner that can not only maintain image density in a normal-temperature normal-humidity environment, in a high-temperature high-humidity environment, and in a low-temperature low-humidity environment but also suppress image fogging after durability printing and disturbances in the toner layer on the development roller after the installation of the toner in a low-temperature low-humidity environment.

The present disclosure finds application in positively chargeable magnetic one-component toner for use in electrophotography. Based on the present disclosure, it is possible to provide magnetic one-component toner that can suppress low image density and image fogging after durable printing and that can also suppress disturbances in a toner layer after the installation of the toner.

What is claimed is:

1. Positively chargeable magnetic one-component toner comprising a toner particle having:
a toner base particle containing at least a binder resin and a magnetic powder; and
an external additive attached to a surface of the toner base particle,
wherein
when the toner is mixed with standard carrier P-01 for 10 minutes such that a mass mixture ratio of the toner to the carrier is x and that a charge amount of the carrier is y, an approximation expression y=b*x^{a} of the charge amount of the carrier fulfills conditions (1) and (2) below:
$$0.3 \leq a \leq 1 \qquad ( 1 )$$
$$- 7 \leq b \leq - 3 \qquad ( 2 )$$
where x=0.2, 0.4, 0.6, 0.8, or 1.0.

2. The positively chargeable magnetic one-component toner according to claim 1, wherein
the charge amount of the carrier is measured after 10 g of the standard carrier P-01 and an amount of the toner that makes the mass mixture ratio x of the toner equal to 0.2, 0.4, 0.6, 0.8, or 1.0 are put in a Turbula shaker-mixer and mixed for 10 minutes.

3. The positively chargeable magnetic one-component toner according to claim 1, wherein
the toner base particle contains a release agent that contains a long-chain fatty acid with a carbon number of 24 or more.

4. The positively chargeable magnetic one-component toner according to claim 1, wherein
the external additive contains:
dry silica; and
wet silica of which a surface of a particle is treated with a positively chargeable silane and a negatively chargeable silane.

5. The positively chargeable magnetic one-component toner according to claim 4, wherein
the surface of the particle of the wet silica is treated with an aminosilane and a fluorine-containing silane.
